(19) United States
(12) Patent Application Publication
(10) Pub. No.: US 2005/0281631 A1
(43) Pub. Date: Dec. 22, 2005

(54) Pin locking system

(75) Inventor: Leon M. Bernstein, Minnetonka, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Kurt Manufacturing Company, Inc., Minneapolis, MN (US)

(21) Appl. No.: 10/872,150

(22) Filed: Jun. 18, 2004

(51) Int. Cl. F16B 13/04

(52) U.S. Cl. 411/24

(57) ABSTRACT

A locking pin system for clamping a fixture plate onto a receiver plate using locating pins that pass into aligning bores on both the fixture plate and the receiver plate. Each locating pin has a cylindrical body with a flange or head on one end and a cone surface at the other end. An axially slotted sleeve with two internal cones is provided in the bore of the receiver plate. A screw with a cone nut is passed through the locating pin so that the nut is on the opposite end of the slotted sleeve from the locating pin. When the cap screw is tightened, one end of the slotted sleeve engages a cone on the pin and the other end of the slotted sleeve is engaged by a cone surface on the nut, to expand as it moves in direction toward the flange and lock the slotted sleeve in place in the bores of the receiver plate. The flanges or heads of the locating pins engage the outer surface of the fixture plate and as the cap screw is tightened, the flanges or head will force the fixture plate against the receiver plate. The flanges have orientation pins held in holes in the fixture plate for identifying and keeping the locating pins from rotation during tightening and untightening of the cap screw.

### BACKGROUND OF THE INVENTION

The present invention relates to a pin locking system for precisely positioning and locking two parts together, specifically for locking a fixture plate for a machine tool in proper position on a receiver plate that is held on the bed of a machine tool.

Fixture plates are used to hold a multiple number of parts in separate fixtures to machine several parts at one machine setting. The fixture plates can be left in the desired configuration and stored while another fixture plate for a different part is installed and used. Machine tools that perform operations on several different parts can use a single receiver plate, and several different fixture plates can be selectively supported on the same receiver plate. If each fixture plate is properly positioned on the receiver plate, the parts that are being machined on the different fixture plates will be precisely positioned after the selected fixture plate has been positioned and clamped on the receiver plate.

### SUMMARY OF THE INVENTION

The present invention relates to a pin locking system for precisely locating and clamping two parts together. Specifically, the two parts as shown are a receiver plate on a machine tool table, and a fixture plate that carries a number of fixtures for holding parts that are to be machined or otherwise worked on by the machine tool.

It is the practice to have a number of fixture plates, each of which is set up to manufacture one particular part. Generally, a number of fixtures are on the fixture plate, so that once the fixture plate is properly positioned on a receiver plate or support, it is known that the parts that are held in the fixtures on each fixture plate will be correctly positioned relative to the machine tool.

The present invention provides a pin locking system, wherein pins are positioned in bores that extend completely through both the fixture plate and the receiver plate so there is no blind hole in which chips can accumulate. Each of the two locating or locking pins consists of a cylindrical body with a flange or head at one end, and a cone shaped exterior surface at the other end. A central cap screw is mounted in a central bore of the locating pin. An axially slotted sleeve with two opposed internal cones is fit and slid with one of the internal cones, an external cone on the end of the locating pin body. A nut with an external cone is engaged with the opposite end of the slotted sleeve is threaded on the central screw. The conical nut has a slot that engages a locking pin dog on the locating pin to prevent rotation of the conical nut when the central screw is threaded to force the conical nut against the internal conical surface of the slotted sleeve. In turn, the nut forces the slotted sleeve up against the exterior conical surface of the locating pin. The locating pin passes through the bore in the fixture plate and the slotted sleeve fits in the bore of the receiver plate. The locating pin head or flange is pressed against the top surface of the fixture plate. The axially slotted sleeve expands and is forced against the surface of the bore in the receiver plate when the central cap screw is tightened, and this action locks the locating pin in the receiver plate bore. The central cap screw then can be further tightened and the cap screw head forces the head of the locating pin against the fixture plate to force the two plates to clamp together.

The head or top flange on each locating pin has orientation pins that will fit into holes in the upper surface of the fixture plate adjacent the correct bore for that locator pin. The one locator pin flange has one orientation pin, and the second locating pin has two orientation pins to ensure that the locating pins are positioned in the correct bore on the fixture plate. Additionally, the orientation pins, when they are received in the holes on the upper surface of the fixture plate, prevent rotation of the locating pins when the central screws are tightened to clamp the fixture plate against the receiver plate.

The locating pins are locked in position on the receiver plate. Two locating pins are utilized, the first locating pin is a close fitting cylindrical pin that passes through the aligning bores on both the fixture plate and the receiver plate that supports the fixture plate. The first locating pin is a pivot pin that holds the aligning bores in both plates concentric. The second pin is placed in aligning through bores in both plates and is spaced from the first pin. The second pin also passes into the bores in both plates and times them. The second pin has narrow cylindrical surface rib portions, one diametrically opposite sides that engage the fixture plate bore and an upper portion of the receiver plate bore. The second pin has a pair of recesses that form concavities in its outer surface partially around the second pin on opposite sides for a portion of length of the pins. The recesses are spaced to leave the narrow cylindrical surface ribs. Because of the recesses, the bores for the second pin in the fixture plate and receiver plate do not have to precisely line up in a direction parallel to a line between the centers of the bores for the first and second pins. This makes precise positioning and clamping easier.

### BRIEF DESCRIPTION OF THE DRAWINGS

FIG. 1 is a top plan view of a fixture plate mounted onto a receiver plate and with bores made to receive locating pins made according to the present invention;

FIG. 2 is an exploded view showing the fixture plate and the receiver plate in registry, with the locating pins of the present invention positioned above their respective bores;

FIG. 3 is a fragmentary sectional view showing the two locating pins holding the fixture plate in its position on the receiver plate;

FIG. 4 is a fragmentary side view of a lower clamping portion of one of the locating pins showing the way the pins are held in the bores in the receiver plate;

FIG. 5 is a fragmentary sectional view as taken on line 5-5 in FIG. 3;

FIG. 6 is a sectional view similar to FIG. 3 showing the locating pins with flanges or heads recessed into the fixture plate; and

FIG. 7 is a view showing the bores for the locating pins lined with hardened bushings, and in position to receive the locating pins.

### DETAILED DESCRIPTION OF THE PREFERRED EMBODIMENTS

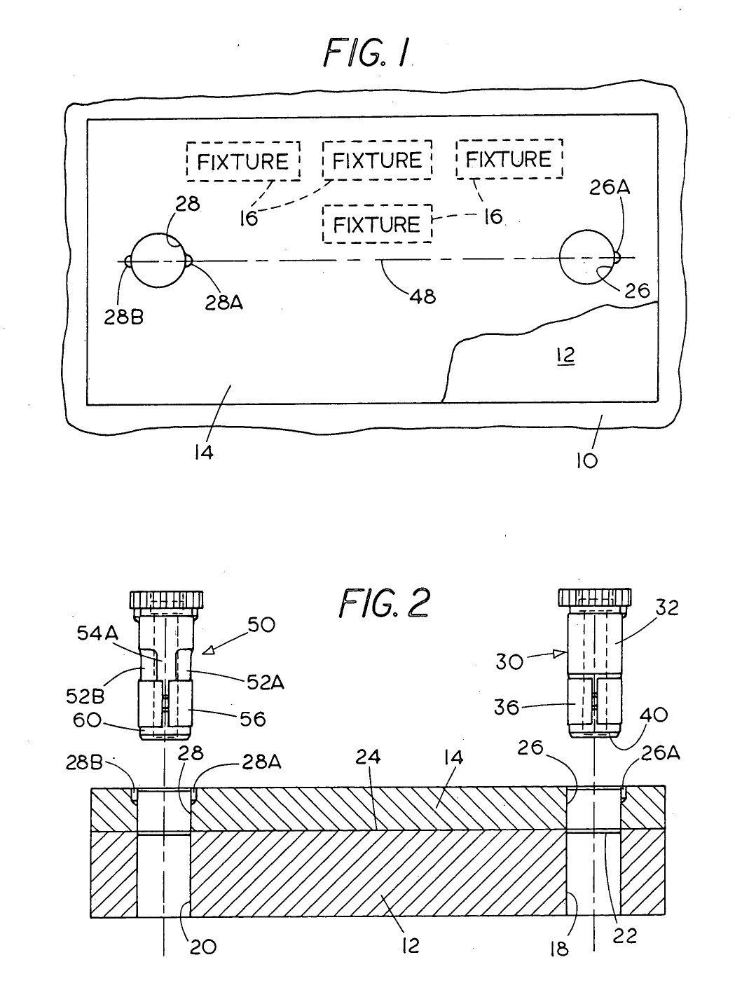

Referring to FIG. 1, a tooling support portion of a machine tool 10 is illustrated. It can be a tower or a table, which supports a receiver plate 12 on which a fixture plate 14 is to be mounted. The fixture plate 14 carries a number of pre-set fixtures, represented by dotted lines at 16 in FIG. 1. The fixtures 16 on each fixture plate are generally for identical parts.

The number, type and placement of the fixtures 16 will be selected by an operator. The fixture plate 14 can be removed from the receiver plate 12, and stored with the fixtures 16 in place. A different fixture plate can then be mounted on the receiver plate. The original fixture plate can be returned for use when the parts that are to be held in the fixtures 16 for machining are to again be produced.

The existing receiver plates generally have a threaded bore for a threaded connection pin for holding the fixture plate in position, which, because of tolerances of threads, permits some shifting and does not provide precise repeatability in the position of the fixture plate. If the threaded bore in the receiver plate is a blind hole, it can collect chips or other debris. With the present system, many of these problems are completely eliminated or at least reduced.

As shown in FIG. 2, the receiver plate 12 has a first and second spaced apart through bores 18 and 20. There are no blind holes in which chips or other debris can collect. The bores are close tolerance cylindrical bores. The bores 18 and 20 can have chamfers 22 at an upper edge, adjacent an interface plane surface 24 that supports the fixture plate 14. The plane of the surface is a junction plane between the two plates.

The fixture plate 14 has a first bore 26, and a second bore 18 that are the same diameter as and co-axial with the respective bores 18 and 20 of the receiver plate 12 when the fixture plate 14 is properly positioned.

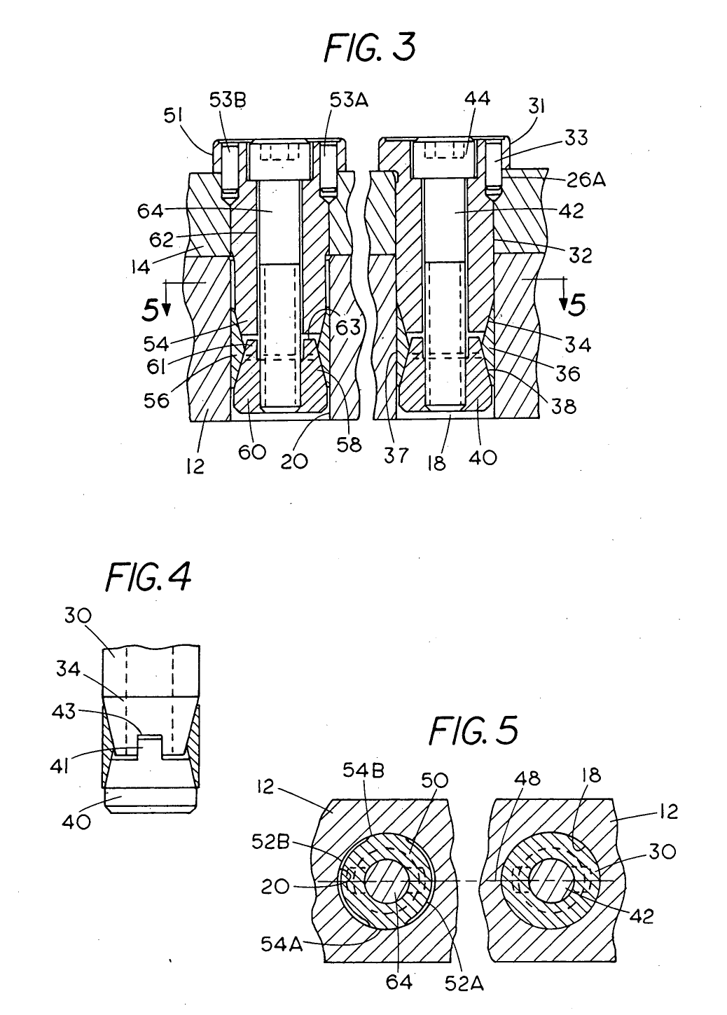

The fixture plate 14 is positioned on the receiver plate 14 with the axes of the bores 26 and 28 aligning. A primary or first locating round pin 30 is placed in these bores. The locating round pin 30 has a stud section with a cylindrical outer surface 32 and a flange or head 31. Cylindrical surface 32 closely fits within both of the bores 26 and 18. The distal end portion of the locating round pin 30 has an outer conical, tapered cam surface 34 as shown in FIG. 3. The locating pin 30 has a central hole 42 in which a cap screw 44 is placed.

A slotted sleeve 36 having a longitudinal slot along its length is positioned around the cap screw 44 in bore 18 and has internal conical surfaces at both ends. One end inner conical surface of the slotted sleeve engages cam surface 34. A nut 40 that is threaded onto the end of cap screw 42 and has a conical end surface 38 that engages the second inner conical end surface of slotted sleeve 36.

When the cap screw 44 is tightened, the slotted sleeve 36 expands full length. The nut 40 has a dog 41 that fits into a slot 43 on the locating pin 30 so the nut 40 can be tightened from the top of the fixture plate 14 without turning in the bore.

As shown in FIG. 3, when the cylindrical surface 32 of locating pin 30 is in position and partially in both of the bores 18 and 26, the two bores 26 and 18 are precisely aligned. Also as shown in FIG. 3, the head 31 of the locating pin 30 has a single orientating pin 33 that fits into pin hole 26A, to keep the locating pin 30 from turning when the cap screw 44 is tightened, and also to make sure the proper locating pin is inserted in bores 28 and 18.

A secondary generally diamond shape cross section locating pin 50, which is shown in FIG. 2 and also in FIG. 3, is provided for positioning and securing the fixture plate 14 relative to the receiver plate 12. The locating pin 50 has a stud portion with narrow cylindrical surface ribs or lands 54A and 54B (FIG. 5) that are diametrically opposite and which fit closely into the bores 28 and 20 when the bores are aligned. The stud portion of secondary locating pin 50 has recesses 52A and 52B on opposite sides of the pin that each extend part way around the pin but leave the cylindrical surface lands 54A and 54B. The cylindrical surface lands 54A and 54B fit closely in the bores 20 and 28 so the bores 20 and 28 are precisely aligned in the direction perpendicular to a line 48 between the central axes of bores 28 and 26 of the fixture plate.

The axial lengths of recesses 52A and 52B span or cross the interface or plane surface 24 between the receiver plate and the fixture plate, so secondary locating pin 50 will not bind in the bores in the direction along line 48.

The secondary locating pin 50 has a center bore 62 in which a cap screw 64 is placed. The secondary locating pin 50 has a conical outer cam surface 55 at its distal end. A slotted sleeve 56 is placed around cap screw 64 and fits into the bore 20. Slotted sleeve 56 has interior conical wedge surfaces at both ends. One conical end surface of slotted sleeve 56 mates with conical end surface 55 of secondary locating pin 50. A conical nut 60 has a conical outer end surface 58 that engages the inner conical surface of the slotted sleeve 56 at an end opposite from the end of the secondary locating pin 50. The cap screw has a head 65 that fits in a recess in the head or flange of secondary locating pin 50. When cap screw 64 is tightened, the slotted sleeve 56 is pulled up against the surface 55, and the opposite end is engaged by the conical surface of the nut 60, so the slotted sleeve is expanded along its full length. The slotted sleeve locks the secondary locating pin 50 in position, the bore 20 in the receiver plate 12.

The head 51 of the secondary locating pin 50 has a pair of orientating pins 53A and 53B, which fit into orienting pinholes 22A and 22B in the top of the receiver plate to keep the secondary locating pin oriented and to keep it from rotating. The two orientating pins 53A and 53B insure the correct pin is in the bores 20 and 26, since the first locating pin 30 has only one orientating pin.

The conical nut 60 has dogs 61 that fit into slots 63 formed in the conical end of the secondary locating pin 50, to prevent the conical nut 60 from rotating when the cap screw 64 is tightened.

The initial tightening of the cap screws 42 and 64 first expands the respective slotted sleeves 36 and 56 to secure or lock the locating pins 30 and 50 to the receiver plate 12.

The pin locking action of the locating pin 30 and the secondary locating pin 50 is identical. The respective locating pins, with the central cap screws, slotted sleeve and the conical nuts are placed, with the stud portions of the locating first pin 30 and the secondary locating pin 50 positioned as shown in FIG. 3. The conical nuts will be initially loosened, so that the split sleeves fit into the respective bore in the receiver plate. When the cap screws 42 and 46 are actuated, the conical nuts 40 and 60, respectively, will move axially up against the expandable slotted sleeves, and then at the same time the respective slotted sleeve is moved axially in a direction toward the conical surfaces at the ends of the stud portions of the locating pin 30 and the secondary locating pin 50. The slotted sleeve of each pin is expanded at both ends so that the slotted sleeves are locked in the receiver plate bores. The stud sections of the locating pin 30 and the secondary pin 50 can move down along the conical inner surface of the slotted sleeves. The flanges or heads of the locating pin 30 and the secondary locating pin 50 will be forced against the upper surface of the fixture plate, to squeeze the two mating surfaces of the fixture plate and the receiver plate together.

This squeezing clamps the fixture plate 14 positively in place, since it is positioned by the stud cylindrical surface 32 of the locating pin 30, and the part cylindrical lands 54A and 54B of the secondary locating pin 50. The slotted sleeves 36 and 56, when they expand, very tightly grip the inner surface of the respective bore in the receiver plate 12, and the squeezing or clamping force between the fixture plate 14 and the receiver plate 12 can be a few thousand pounds. The fixture plate 14 and the receiver plate 12 are tightened together with both the locating pin 30 and the secondary pin 50.

The slotted sleeves 36 and 56 are shown with longitudinally straight slots, but these slots can be spiraled, if desired. A sleeve with a few partial length slots at both ends of the sleeve will radially more evenly expand when the respective conical surface on the nut and the conical surface on the stud portions of the locating pins spread or expand the end portions of the sleeve.

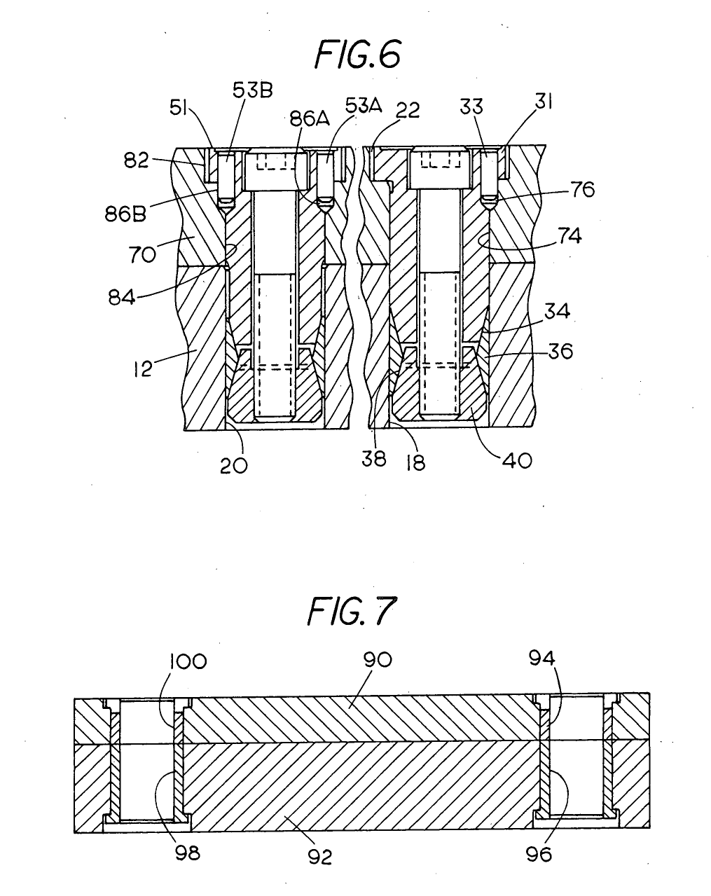

FIG. 6 shows a modified fixture plate 70 that has a recess or counter bore 72 surrounding the bore 74. Bore 74 is the same as the bore 26 in the fixture plate 14, but the recess permits the flange or head 31 of the locating pin 30 to be flush with or slightly below the top surface of the fixture plate 70. Orienting pin hole 76 for the orienting pin 33 of the location pin 30 is formed in the inner end of counter bore 72.

Likewise, the secondary locating pin 50 is shown in FIG. 6 with the flange or head 51 in a counter bore or recess 82 in the fixture plate 70. The recess 82 surrounds a bore 84 that corresponds to the bore 28. The orientating pins 53A and 53B fit into orienting holes 86A and 86B that extend into the inner surface of the recess 82. The locating pins will tighten and clamp the fixture plate 70, and receiver plates together as previously described.

Both heads or flanges of locating pin 30 and secondary pin 50 are flush with or slightly below the surface of the fixture plate 70 to avoid projecting above the fixture plate surface.

FIG. 7 illustrates a modified fixture plate 90 and a modified receiver plate 92. A hardened bushing or sleeve 94 is inserted in the bore in fixture plate 90 for the locating pin 30, and hardened bushing or sleeve 96 is inserted in the bore in the receiver plate 92. A hardened bushing 98 is inserted in the receiver plate for secondary locating pin 50 and a hardened bushing 100 is inserted in the corresponding bore in the fixture plate. Bushing 98 and 100 are sized for the secondary locating pin 50. The hardened bushings ensure that the tightening of the split sleeves on locating pin 30 and secondary locating pin 50 will not cause the metal defining the bores in the receiver plate and the fixture plate to deform or wear.

The pin locking system is reliable, repeatable, and does not have limitations of existing attachment systems for attaching fixture plates to receiver plates.

Although the present invention has been described with reference to preferred embodiments, workers skilled in the art will recognize that changes may be made in form and detail without departing from the spirit and scope of the invention.

1. A locating lock pin system for clamping two parts together along an interface, a through bore through each of the parts, the bore on one part aligning with the bore on the other part, a locating pin passing through the bore of the one part and into the aligning bore of the other part, the locating pin having a head flange for stopping axial movement of the pin relative to a surface of the one part, and an expanding sleeve positioned in the bore of the other part, the locating pin having a central bore, a screw in the central bore in the locating pin and having a head flange bearing on the head of the locating pin, the screw extending through the locating pin, an expanding sleeve mounted on the screw, a nut on the screw within the bore on the other part, and on an opposite end of the expanding sleeve from the locating pin, the nut being moveable against an end of the sleeve when the screw is tightened, and at least one set of mating wedge surfaces at an end of the sleeve to expand the sleeve as the screw is tightened so the sleeve engages a surface of the bore of the other part.

2. The locating lock pin of claim 1, wherein the wedge surfaces comprise an internal conical surface at one end of the expanding sleeve, and an external conical surface on an end of one of the pin and the nut.

3. The locating lock pin of claim 2, wherein the expanding sleeve has internal conical surfaces at both ends thereof, an external conical surface on one end of the locating pin engaging one of the internal surfaces, and an external conical surface on an end of the nut engaging the internal conical surface at the other end of the sleeve.

4. The locating lock pin of claim 1, wherein the locating pin has a cylindrical surface that closely fits the bore of the one part.

5. The locating lock pin of claim 2, wherein said nut forces the expanding sleeve against an end of the locating pin to expand the sleeve, move axially in direction toward the flange and clamp one part and the other part.

6. The locating lock pin of claim 3, wherein said expanding sleeve has a slot that extends along the axis of the screw, so that the sleeve expands along its entire length to grip the surface of the bore of the other part.

7. The locating lock pin of claim 1, wherein the locating pin has surface portions which engage surfaces of the bore in the one part, and has other portions which are recessed inwardly to clear the surface of the bore of the one part, and of a length to span the interface.

8. An pin locking for securing first and second parts together in repeatable positions wherein the parts have a mating surface along an interface, at least two through bores through each of the parts, the bores on the first part aligning with the bores on the second part, locating pins for holding the parts together, the locating pins each passing through a bore of the first part and at least partially into the aligning bore of the second part, each locating pin having a head for stopping axial movement of the pin in a selected position relative to the first part, the locating pins each having a central bore, a screw in each central bore, a separate expanding sleeve on each screw positioned in the bore of the second part, a separate nut on each screw on an opposite side of the respective expanding sleeve from the respective locating pin, the nut being threadable against the sleeve to move the sleeve toward the locating pin, and at least one pair of wedge surfaces at one end of the sleeve to expand the sleeve as the screw is tightened to secure the sleeve in the bore of the second part.

9. The apparatus of claim 8, wherein a first of the locating pins is positioned in first bores of the parts, the first pin having a cylindrical outer surface closely fitting the bore on the first part, a second of the locating pins in second bores of the parts and having recesses on the outer surface that are centered on a line between the centers of the bores on the first part.

10. The apparatus of claim 8, wherein each of the locating pins is held in the respective bore in the second part with a wedge mating with an annular split sleeve having a tapered interior wedge surface, and each locating pin having a threaded member for moving the respective wedge axially relative to the respective locating pin to expand the annular split sleeve.

11. A securing apparatus for mounting a fixture plate having a plurality of machine tool fixtures thereon onto a receiver plate of a machine tool, the receiver plate having first and second spaced apart bores through the receiver plate, the fixture plate having third and fourth spaced apart bores through the fixture plate and aligning with the first and second spaced apart bores in the receiver plate, respectively, and first and second locating pins passing through the third and fourth bores and at least partially into the aligning first and second bores, respectively, each of the locating pins having portions that closely fit within the third and fourth bores, and having cone operated expanding sleeves on portions of the locating pins within the first and second bores, respectively, the first locating pin having a full sized cylindrical portion closely fitting in the first and third bores across an interface between the receiver plate and the fixture plate, and the second locating pin having part annular recesses therein to reduce the effective diameter of the second locating pin along a line between the axes of the third and fourth bores, the recesses spanning the interface between the fixture plate and the receiver plate.

12. The apparatus of claim 11, wherein the second locating pin has part annular lands are on opposite sides of the second locating pin along a line perpendicular to the line between the third and fourth bores.

13. The apparatus of claim 11, wherein the recesses of the second locating pin are spaced to leave full size cylindrical lands centered on a diameter line of the second pin perpendicular to a line between central axes of the third and fourth bores.

14. The apparatus of claim 11, wherein said first, second, third, and fourth bores have hardened bushings lining the surfaces of the bores.

15. The apparatus of claim 13, wherein said first and second locating pins each have different orienting members to permit the locating pins to seat only when the locating pins are in the selected bores for the respective locating pin.

16. The apparatus of claim 11, wherein said locating pins have heads to stop movement of the locating pins through the bores in the fixture plate.

17. The apparatus of claim 16, wherein said fixture plate has recesses defined in a surface opposite from the interface for receiving the heads of the respective first and second locating pins.

18. The apparatus of claim 11, wherein the said cone operated expanding sleeves are each operated by a separate nut having a cone wedge engaging a cone on an end of the respective expanding sleeve, and a separate cap screw rotatably mounted in a central bore in a respective one of the respective locating pins to thread into the respective nut.

19. The apparatus of claim 18, wherein said expanding sleeves each comprise a slotted sleeve having oppositely facing internal cone surfaces at opposite ends, and each of the locating pins having an end surface that is conical to mate with an inner surface of a respective slotted sleeve and cause expansion on the respective slotted sleeve as the respective nut is moved so the cone wedge engages the respective slotted sleeve at an opposite end of the slotted sleeve from the respective locating pin.
